(19) United States
(12) Patent Application Publication
(10) Pub. No.: US 2006/0095376 A1
(43) Pub. Date: May 4, 2006

(54) Virtual meetings

(76) Inventors: Arthur Mitchell, Manila (PH); Philippe Bennett, New York, NY (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/521,065

(22) PCT Filed: Dec. 20, 2002
(86) PCT No.: PCT/US02/41357

§ 371 Date: Jan. 12, 2005

(51) Int. Cl. G06Q 99/00

(52) U.S. Cl. 705/50

(57) ABSTRACT

System, method, signal, operating model, and computer program for conducting a meeting over an electronic network. The method comprises steps of providing the eligible participants with a notice of the upcoming meeting at an address to which they have consented to receiving such notices. The method further comprises secure communications during the meeting between the several eligible participants attending such meeting. Moreover, the method of the meeting over an electronic network of the present invention provides for secure voting by the several eligible participants attending the meeting in accordance with their respective voting rights.

### FIELD OF THE INVENTION

The present invention relates to a method and system for providing secure meetings on a wide area network such as the global computer network, or on a local area network. Among things, the present invention permits those attending the meeting on the network to vote securely by an electronic transmission.

### BACKGROUND OF THE INVENTION

The prior art has considered various means of voting via electronic communication networks, for instance the procedures described in of U.S. Patent Applications Nos. U.S. 2002/0087394 of Zhang published Jul. 2, 2002; U.S. 2002/0095389 of Gaines published Jul. 18, 2002; U.S. 2002/0103696 of Huang et al. published Aug. 1, 2002; U.S. 2002/0133396 of Barnhart et al. published Sep. 19, 2002; and U.S. 2002/0138341 of Rodriguez et al. published Sep. 26, 2002, each of which is hereby incorporated by reference.

However, such voting methods have not considered the particular needs of for instance, a shareholders meeting. Among particularities, shareholders meetings are governed by the law of the jurisdiction under which they are formed, and many jurisdictions have unique requirements. Given the prevalence of Delaware as the state of incorporation of American corporations, it is preferred that any secure means of electronic communication is adopted to conform to the requirements of Delaware Corporate Law.

Others have attempted to adopt electronic communications to virtual meeting that conform to the requirements of Delaware Corporate Law. For instance, Mark S. Britton, Electronic Stockholders Meetings—Delaware Begins the Next Chapter, CORPORATE GOVERNANCE ADVISOR (September/October 2000); Jesse A. Finkelstein, Shareholder Meetings in Cyberspace: Will Your Next Meeting Location Be a Website?, INSIGHTS (June 2000); and C. Stephen Bigler, 2000 Amendments to the Delaware General Corporation Law, INSIGHTS (August 2000), each of which is hereby incorporated by reference with respect to their disclosure of virtual meetings.

### SUMMARY OF THE INVENTION

The present invention provides a method of remote communication that facilitates confidential and secure decision making in corporate or other bodies in accordance with applicable legal procedures. Desirably, a shareholder is able to express his views on issues submitted to the shareholders by means of an electronic transmission that is both secure and verifiable. In one embodiment of the present invention, a means of communication such as telephone, electronic bulletin board, e-mail, instant messaging, the Internet, webcasting, video streaming, or any other form of electronic transmission and physical meetings or any combination thereof, using verification and encryption technologies to ensure that the identity of each person entitled to vote has been verified (hereinafter an “Authorized Voter”) and that the voting process is free from tampering.

The method of the present invention may be used to facilitate voting at meetings of a wide variety including, but not limited to general or special shareholder meetings of corporations, partnership meetings, meetings of membership associations and not-for-profit corporations, bond holder meetings, and meetings among unit-holders of unit trusts or similar vehicles (each of the foregoing being hereafter referred to as the “Company”) or meetings of the Board of Directors of a Company, where such voting may be conducted, in whole or part, by electronic means, in accordance with applicable law.

The method of the present invention is designed to be employed in Japan, the various states of the United States and those jurisdictions in Western Europe where electronic voting is permitted. The method is to be used in conjunction with customary corporate or other governance procedures during the conduct of a duly authorized meeting and is intended to enable such meetings through electronic means.

In general, the method of holding a meeting of the present invention includes a plurality of the following steps: notice to the eligible participants; convocation of the meeting; commencement of the meeting, conducting the meeting; polling the attendees on matters put to a vote of the eligible participants at the meeting; conducting any further business; closing the meeting; and ancillary steps such as providing notice, obtaining consents, delivering documents and permitting solicitations of votes of eligible participants.

1. Notice. In a preferred embodiment of the present invention, notice of the convocation of the meeting is given by e-mail or other electronic means (in addition to other communication means, if desired), no later than the minimum number of days required by applicable law for such notice. For instance, if the organization holding the meeting has the e-mail addresses of its eligible participants and such participants have consented to receiving notice by e-mail, the organization sends such participants notice of an upcoming meeting by e-mail.

In one embodiment of the present invention, prior to the meeting, eligible participants are permitted to access the list of eligible participants in a manner that enables them to send out materials to the other eligible participants. For instance, an eligible participant could send out materials soliciting votes for a Board of Directors different from the slate of Directors nominated by management.

In an alternative embodiment of the present invention, notice may be given effectively to eligible meeting participants as set forth in relevant statutes, the certificate of incorporation, or the bylaws shall be effective if given by a form of electronic transmission consented to by the eligible participant to whom the notice is given. Any such consent shall be revocable by the eligible participant by written notice to the organization. Any such consent shall be deemed revoked if (1) the organization is unable to deliver by electronic transmission 2 consecutive notices given by the organization in accordance with such consent and (2) such inability becomes known to the secretary or an assistant secretary of the organization or to the transfer agent, or other person responsible for the giving of notice; provided, however, the inadvertent failure to treat such inability as a revocation shall not invalidate any meeting or other action.

Desirably, when notice is given by a posting to a website by the organization, and the organization provides the eligible participants with notice of the posting, the secretary or other agent of the organization makes a record of the facts.

2. Convocation. On the day and at the time set for the convocation of the meeting as set forth in the notice, an appropriate officer of the Company shall certify that a quorum is present or represented by proxy. Presence or attendance at the meeting shall be demonstrated by physical presence, encrypted e-mail, or other secure means. In one embodiment of the present invention, eligible meeting participants log in to a website and once logged in, they are present for the meeting until they log off. Following convocation of the meeting, the appropriate officer shall execute all other formalities required by applicable law prior to commencement of the meeting.

In a particularly preferred embodiment of the present invention, eligible meeting participants log in to a secure website that records their present at the web meeting. Additionally, the website is able to poll the logged in participants at some predetermined interval, for instance once every 5 or 10 minutes, to ensure that the participant is still in attendance. If the participant does not respond to the polling, the participant is considered to have left the meeting and is not counted for quorum or other purposes until they log in again.

3. Commencement of Meeting. The Chairman of the meeting shall call the meeting to order and make all statements normal and customary at such time. All statements by any officer of the Company and any Authorized Voter shall be recorded and immediately transmitted to all Authorized Voters and Company officers attending the meeting. The Chairman of the meeting shall execute all other formalities required by applicable law following commencement of the meeting.

In one embodiment of the present invention, the meeting is conducted on a website. For instance, there can be a webcast of a physical meeting including the chair, or the meeting could consist of a plurality of pages posted to the website that are progressively made available as the meeting progresses. One or more of these pages could have audio files corresponding to text files or instead of text.

4. Conduct of Meeting. The Chairman of the Meeting shall make such reports as shall be required by applicable law or thought desirable by the Chairman. Other officers or people designated by the Chairman shall also make such reports that are necessary or desirable. All such reports and communications shall be recorded and concurrently transmitted to all Authorized Voters and Company officers.

Additionally, the chair could permit one or more of the eligible meeting participants to make their own presentations. In one embodiment of the present invention, there is a time delay from the submission of a webpage from a participant before the submitted page is posted to enable the chair, or one or more persons acting on behalf of the chair, to vet any submitted pages to ensure that the submitted pages comport with any applicable standards for submissions from persons attending the meeting. For instance, the submitted page could address a matter of corporate governance that the laws governing the organization reserve exclusively for the Board of Directors. In such a case, the chair, or his designee, could lawfully withhold the posting of such material.

5. Voting. The Chairman of the meeting or other officer of the Company shall put forth proposals that are to be voted upon by Authorized Voters. Following each proposal, discussion on each such proposal may take place using any of the communication means set forth above. Thereafter, the Chairman or other officer of the Company shall call for a vote. A vote on each proposal may be cast by paper ballot or encrypted electronic ballot (an e-ballot), or other form of electronic transmission.

Following each vote, an appropriate officer shall record the results of the vote in the Company records and make the results known to the Authorized Voters in accordance with Company procedures. At the end of the voting, the Chairman or other officer will close the polls.

Heretofore, current approaches to provide a secure voting system on a wide area or local area network have traditionally emphasized purely cryptographic-protocol-based solutions to secure the voting. The work done to date is largely purely research into specific issues in secure electronic voting and does not address the practical application into a real-world system. The prior art has approached worldwide area network, for example, on the global computer network known as the Internet, elections as an extension of secure, electronic commerce techniques without providing a comprehensive approach to the significant threats, vulnerabilities and risks that threaten the security, authenticity and reliability of such elections.

Electronic transmission elections must achieve the objectives of conventional elections, specifically: “democracy” (only registered citizens may vote in accordance with their respective voting rights—for instance, the vote of a holder of 1000 shares will be accorded ten times the weight of the vote of the holder of 100 shares), accuracy (votes may not be altered, forged or deleted), “privacy” (no one may know how anyone else voted or prove how they voted), and “verifiability” (everyone should be able to verify their own ballot, as well as the correctness of the entire election). Moreover, electronic transmission elections address additional capabilities: “mobility” (individuals should be able to vote from any Internet-accessible location, at any legal time), “convenience” (voting should be simple and convenient for everyone), and “flexibility” (the technology should be applicable to all elections).

Electronic transmission voting systems must achieve these objectives in the face of both conventional election threats, and threats specific to automated, distributed computer systems, including: fraud, abuse of privilege (privileged individuals may act inappropriately), denial of service (computer services may be impaired or rendered inaccessible), software flaws, tampering (of recorded ballots or other data), malicious software, wiretapping (sniffing, modification or replay of communications), vote selling, or masquerading (by client/server computers or by people).

The prior art has taken several approaches towards electronic transmission election systems. Electronic commerce or E-Commerce approaches rely on securing communications through encrypted connections and verifying individual identity only through weak or single-factor authentication (e.g., passwords). Encrypted Absentee Balloting systems emulate conventional absentee balloting by using ballots that are doubly encrypted using symmetric keys. Cryptographic protocols, particularly those relying on asymmetric or public-key cryptography hold the greatest promise but have been relegated largely to the academic community.

All these techniques have characteristic weaknesses. E-Commerce techniques secure only voter-system communications. They provide weak authentication and no (strong) mechanisms for achieving democracy, privacy, accuracy or verifiability. Encrypted Absentee Ballot systems provide better privacy, but provide no stronger mechanisms for democracy, accuracy or verifiability, and are vulnerable to abuse of privilege, potentially compromising the keys used to ensure privacy. Many of the cryptographic protocols developed to date are complex, making implementation verification difficult. Public-key cryptography and digital signature techniques promise strong authentication, accuracy and verifiability. However, the generation and distribution of public-private (secret) key-pairs, and the protection of private keys, makes these techniques difficult to apply to large-scale applications such as electronic transmission voting.

Specifically, it has been recognized that existing private-key management techniques, i.e., PKI approaches, are not acceptable if they require the end users to buy, install or configure anything, or require any particular type of client device. Such considerations become particularly significant when there may be huge numbers of end users, for example, 100,000 to 1,000,000, such as may be the case in an election.

It is recognized that PKI technology supports the use of public-key cryptography by providing various means to generate public-private (secret) key pairs, protect access to the private (secret) key so that it can be used only by the individual with whose identity it is associated, and provide for distribution and convenient access to the public key. Common strategy involves generation of public/secret key pairs on a user's personal computer by an application such as a web browser, storage of the private key within a personal identification number (PIN) protected, encrypted key-store file on the user's personal computer (PC), and exportation of the public key to a certificate authority, for example, where it is wrapped in a digital certificate, such as an X.509 digital certificate, and made available for public access on a lightweight directory access protocol (LDAP) certificate directory service.

This approach has advantages in that it is convenient and the private keys never leave the user's PC. Disadvantages result, however, because even though the private keys are protected in PIN-based encrypted files, PCs offer little protection against key-store cryptoanalysis by malicious software, and user mobility is impaired as it requires effort to export a private key so that it can be used on another platform.

An alternative strategy involves generation of public/secret key pairs on a secure platform rather than the user's PC, for example, a server. Yet still further, the approach involves storage of the private key, and perhaps other authentication-related data, on a storage device such as a password-encrypted floppy disk, or on a password-protected token/dongle, Java-ring (iButton) or smart card devices, as well as exportation of public keys and digital certificates as described with respect to the first approach.

One advantage of this approach is that the private key is more easily accessed from various computers, facilitating mobility, so long as there is a hardware interface for the private-key device. In addition, the private key is better protected within a removable device. Resultant disadvantages include the fact that the server must be verified not to make/leave copies of the private key. In addition, there must be some sort of hardware interface to allow retrieval of the key from the storage device, e.g., disk drive, USB port, iButton/smart card reader, etc. Yet still further, these hardware interfaces may be expensive, difficult to install/configure, and may not be universally available, thus inhibiting mobility.

The advantages and disadvantages of the above-identified two approaches have led to a third approach. In the third approach, generation of public/secret key pairs is done on a secure platform other than the user's PC, for example, a server. The secret keys are stored in encrypted form on the secure server and downloaded to the client over a secure network connection as needed to support authentication, digital signature or encryption operations. The server must authenticate the user by some non-PKI-based method before allowing the user to download their private key. In most cases, this will still require some authentication device.

While providing further refinements and including advantages such as convenience and mobility being improved because private keys are always available from a network server, and no hardware interfaces are required on the client device, significant disadvantages still remain.

Initially, it is noted that there is a need for a secondary strong authentication technique that requires hardware token support, e.g., SecureID. In addition, such hardware tokens incur additional expense, and private keys are stored on a secure server using one or more keys known to the server, thus requiring the server to protect access to and use of these keys.

In all three approaches described, retrieval of private keys from local/network storage is required for use within the memory of a PC or thin-client device, and exposes the key to potential compromise. Only tokens with processors can perform the necessary cryptographic operations without exposing the private key. None of the approaches offer sufficient security, mobility and convenience at a sufficiently low cost to make public/private key cryptographic services, e.g., authentication, non-repudiation, encryption, attractive for applications with a potentially large number of users such as in the case of an election with users numbering from anywhere between 100,000 to about 10,000,000.

In order to make public/private key cryptographic services feasible for such applications, there must be a low-cost way to generate public/secret keys, while providing secure storage for and access to those keys without requiring special hardware or inconvenient procedures. These advantages and other advantages are provided by the system and method described herein, and numerous disadvantages of existing techniques are avoided.

In accordance with one aspect of the invention, there is provided a method of securely voting over a network, which can be a local area network, or a wide area network such as the global computer network known as the Internet. The method involves delivering an electronic ballot from a server with a vote serial number on the ballot, to an individual at a terminal over a connection secured using both the server's and the voter's private keys. Thereafter, the ballot is filled in with the voter's choices, which are digitally signed using the voter's private key. The voter's ballot choices, bearing the voter's electronic signature, and the vote serial number is then delivered to the server. A data element is then created from the individual's digital signature of the ballot choices, the server's digital signature of the voter's ballot choices (created using the server's private key) and the vote serial number to allow recording of the subset of the ballot in a data store at the server, and retaining the ballot information as a vote. This data element is then digitally signed using the server's private key to ensure its integrity and authenticity.

As described herein, the terms “individual”, “user”, “client”, and “voter” are used interchangeably, and refer to a person on their own terminal which can be a personal computer or other like device on which voting in accordance with the method and system herein is achieved.

In a more specific aspect, the retention of the vote at the server can be confirmed by signing the individual's signature of the ballot, the server's signature of the ballot, and the vote serial number, and the signed confirmation is transmitted to the individual who submitted the ballot.

Yet still further, the method involves recording in the server's data store the server's digital signature of the ballot to allow verification at the server that all of the ballots cast have not been tampered with.

In a more specific application, while the ballots are initially described as being generated as an HTML document, to provide additional security, in an alternative form the ballot can be generated in bit-map form such that the intentions of the voter or individual voting may be determined by monitoring the (x,y) coordinates of their mouse-clicks on the ballot bit-map. This provides enhanced security, since to read bit-map documents requires advanced optical character recognition technology, which in turn requires and imposes a large computing power overhead, thus making malicious hacking into the system significantly more difficult and detectable.

In an alternative aspect, there is described a system for conducting secure voting over a network, for example, the global computer network known as the Internet, or on a local area network. The system includes a server having a data store associated therewith. The server is configured for connection to the network for communicating with terminals connected to the network. The server is further configured for delivering an electronic ballot having the vote serial number on the ballot, to an individual at a terminal connected to the network, and the ballot being configured for being filled in by the individual, and for having a subset thereof delivered to the server with the individual's electronic signature, and the vote serial number thereon.

Yet still further, the server is further configured for receiving the ballot choices and creating a data element from the electronic signature of the individual's ballot choices, the server's electronic signature of the individual's ballot choices, and the vote serial number to allow recording of the ballot choices in the data store and retained therein as a vote. This data element is then digitally signed using the server's private key to ensure its integrity and authenticity.

In a further aspect, the server is programmed for confirming retention of the vote at the data store by signing the individual's signature of the ballot choices, the server's signature of the ballot choices and the vote serial number, and thereafter transmitting the signed confirmation to the individual who submitted the ballot.

Yet still further, the system provides that the server is programmed for recording in the data store the server's digital signature of the ballot choices for allowing verification at the server that all of the ballots cast have not been tampered with.

In a still further aspect, the system is capable of generating the ballot as either a bit-map or an HTML document. The advantage of the bit-map document is that tampering or hacking becomes more difficult because bit-map documents require optical character recognition as previously discussed, such that malicious hacking is not easily achieved without detection.

6. Further Business. The Chairman may elect to continue the meeting to discuss further business, followed by questions and answers, using all of the foregoing communication means.

7. Close of Meeting. The Chairman of the meeting shall declare the adjournment of the meeting at the close of its business.

8. Other Procedures. If permitted by applicable law, the system described herein may be used to complete all other corporate procedures such as the solicitation and receipt of consents, waivers, or the posting and delivery of corporate notices, documents, or a combination thereof.

### BRIEF DESCRIPTION OF THE FIGURES

FIG. 1 illustrates a preferred embodiment of the notice to potential meeting attendee aspect of the present invention;

FIG. 2 illustrates a preferred embodiment of the initiation of the virtual meeting of the present invention;

FIG. 3 is a system-level architectural view of how an operational system implementing electronic transmission voting over a network, such as the global computer network known as the Internet, can be configured;

FIG. 4 is a block diagram illustrating the flow of the electronic ballot and associated data elements between an individual or client side, and a server side, managing the electronic transmission voting method;

FIG. 5 is a block diagram showing in greater detail the components, and data information exchange illustrated in FIGS. 3 and 4; and

FIG. 6 is an architectural diagram showing in greater detail how a system and method as described herein could be deployed on a broad basis on a network such as the global computer network known as the Internet.

### DETAILED DESCRIPTION OF THE PREFERRED EMBODIMENTS

It is preferred that the electronic transmission used effectuate any eligible participant voting in an embodiment of the present invention is able to create a record that may be retained, retrieved and reviewed by a recipient thereof, and that it may be directly reproduced in paper form by the recipient through an automated process.

It is further preferred that any eligible participant making a presentation at a meeting according to the present invention can be heard by each of the other eligible participants attending the meeting.

It is yet further preferred that any meeting of eligible participants conducted according to the present invention is recorded in a format that can be retrieved subsequently to reasonably verify that the proceedings occurred and that the meeting was conducted in a substantially fair manner.

It is still further preferred that a list of the eligible participants entitled to attend and vote at the meeting is available to the other eligible participants, upon verification of their status as and eligible participant entitled to attend and vote at the meeting. It is even further preferred that the list of eligible participant s entitled to attend and vote is available to such eligible participant s for at least the period of time from the posting of the notice of meeting until the end of the meeting.

It is also preferred that the organization holding the meeting maintains a database of its eligible participant s including the address (physical and electronic) of the eligible participants and which, if any, means of electronic transmission by which the eligible participants consent to receive notices from the organization holding the meeting.

Turning now to FIG. 1, organization 1 wishing to conduct a virtual meeting retains virtual meeting host 2. At some time prior to the virtual meeting, organization 1 provides each of the prospective meeting attendees 3 with a notice of the upcoming meeting. Desirably, said notice of the upcoming meeting conforms to all the formal requirements of such a notice.

For instance, if organization 1 is a social club with a set of by-laws that specifies what must be included in the notice of a meeting of organization 1, then this notice should conform to those by-laws. Alternatively, if organization 1 is a corporate entity and it seeks to have a meeting of its shareholders, for instance a special meeting of the shareholders, and if there are laws governing what must be in any notice of a shareholder meeting, then this notice should conform to such laws. For example, the notice might specify the date and location (either physical or virtual) of the upcoming meeting as well as an agenda of items to be considered at such meeting.

If organization 1 does not have the electronic address for each of the prospective meeting attendees 3, the notice might also solicit the same.

Typically, if organization 1 wishes to hold a virtual meeting, it retains a virtual meeting host 2. On retaining the virtual meeting host 2, organization 1 provides virtual meeting host 2 with electronic address information for each of the prospective meeting attendees 3. Desirably, the notice of the upcoming meeting asks the prospective meeting attendees 3 to forward their electronic addresses to said virtual meeting host 2.

Once organization 1 has provided notice to the prospective meeting attendees 3 and retained virtual meeting host 2, virtual meeting host 2 contacts each prospective meeting attendee 3 to arrange for the prospective meeting attendees 3 to have the software necessary to attend the virtual meeting electronically in a secure and encrypted fashion.

Once each of the prospective meeting attendees 3 has their notice and necessary software, the prospective meeting attendees 3 can then install such on their respective workstations. Thereafter, at, or shortly before the date and time set forth in the meeting notice, the prospective meeting attendees 3, as shown in FIG. 2, can communicate with virtual meeting host 2 and log onto the host's system, thereby entering the virtual meeting space.

In an alternative embodiment of the present invention, in addition to permitting an appropriate person—e.g., a member of an organization or a shareholder—to attend a virtual meeting electronically, the virtual meeting system of the present invention can permit such an appropriate person to designate, or revoke a prior, proxy for the purposes of attending and acting at the meeting. Indeed, the virtual meeting system of the present invention can permit a person to attend one or more parts of a meeting and designate a proxy for any other parts of said meeting.

In a further alternative embodiment of the present invention, instead of using digital certificates to authenticate electronic admission to the virtual meeting, another means of remote authentication is used such as a password or biometrics.

In a further alternative embodiment of the present invention, using a means of electronic authentication, the prospective meeting attendee is given access to materials relevant to such a meeting. For instance, if the meeting is a listed Company shareholders' meeting, the prospective meeting attendee can be given access to the shareholder list, can deliver and receive electronic consents, proxies, options, warrants and other documents.

In a preferred embodiment of the present invention, when the virtual meeting attendee is logged into the meeting, the attendee's workstation has a plurality of windows available having information that might be relevant to the meeting. For instance, when the virtual meeting is a shareholders' meeting for a listed Company, the prospective meeting attendee's workstation can have open windows that display the text of any financial statements, proxy statements, security filings, resolutions to be considered at the virtual meeting, or other business records.

### EXAMPLE 1

In one embodiment of the present invention, in preparation for the virtual meeting, the organization desiring to hold a virtual meeting retains a virtual meeting host.

Prior to the virtual meeting, the virtual meeting host gives each person authorized to attend the virtual meeting (i) a notice of the meeting consistent with any applicable rules or laws for such meeting and (ii) a Meeting Number. For instance, if the virtual meeting is for shareholders of a Company, the virtual meeting host gives each shareholder of a record date as set by the Board of Directors of the company, notice of the shareholder meeting and a Meeting Number. In addition, each person authorized to attend the virtual meeting obtains a digital certificate—which may function as an encryption key, a digital signature, or both—from the virtual meeting host.

Each prospective virtual meeting attendee sets up their own “Virtual Meeting Workstation”. In some instances, this set up may require the installation of software provided by the virtual meeting host. Additionally, if the virtual meeting is to provide bidirectional video, “Virtual Meeting Workstation” may require the addition of a video camera.

If the virtual meeting is conducted in real time, then at the specified time, or slightly before, the attendees, using their digital certificate from the virtual meeting host log into the virtual meeting room specified by their Meeting Number. When the number of attendees is sufficient to constitute a quorum, the virtual meeting is called to order.

In the instance where the virtual meeting is a shareholders meeting, an officer of the company calls the meeting to order. Desirably, the notice of the meeting included an agenda. Once the meeting is called to order, the agenda is followed.

When the meeting chair calls for a vote on an item, an encrypted ballot is sent to each person attending the meeting electronically. Any one attending the meeting in person can vote in a traditional manner. Alternatively, persons in physical attendance can be provided with access on site to an electronic vote recording device.

Persons receiving electronic ballots are given a period of time, say five minutes, to cast their ballots. Typically, the time give to those casting ballots electronically is comparable to the time given to those casting ballots in person.

The electronic ballots, when cast are encrypted and sent to the virtual meeting host. As the encryption desirably employs the voters' digital certificate, a digital signature, the virtual meeting host can identify each ballot as received and give each such ballot an appropriate weight. For instance, the ballot from a holder of 1000 shares can count as 10 votes whereas the ballot of the holder of 100 shares may count as a single vote.

In a particularly preferred embodiment, the voter receives an electronic receipt recording his or her ballot as soon as it is submitted.

When the time to submit ballots expires, the virtual meeting host can announce the result of the ballot to all persons attending the meeting, electronically or in person, concurrently.

In an alternative application, the convocation of such meeting as set forth above may be extended over a period of days until a quorum is obtained.

FIG. 3 is a system-level architectural view of how an operational system and method as described herein might be implemented. The client personal computer 11 or PC 11, typically a personal computer running an operating system such as Microsoft Windows., which may optionally include a smart card reader 13 connected thereto, although this is not required. The PC 11 includes network access capability which can be to the local area network, or to a global computer network 17. In the case of a global computer network 17, the PC 11 would have access to the global computer network 17 through, for example, an Internet service provider (ISP) 15, or alternatively, access to other parts of the network might be through a direct cable modem, or a local, or a network attachment to the global computer network 17.

On the server side, there is provided a primary interface to the entire system through a web server 19 in a conventional manner which is well known to those of ordinary skill in the art, and which is common to most electronic commerce architectures. The web server 19 interoperates with a certificate authority 21, which can be for example, an enterprise server suite such as that available from Netscape Corporation. The certificate authority 21 uses a certificate-generating system, such as one like that available commercially under the name iPlanet, which is conventional, and which is one of many alternatives which can be used to implement the functionality described herein.

In addition, the web server 19 can also interoperate and be connected to a back end application or database server 23 and an LDAP certificate directory server 25.

Respect to the LDAP certificate directory server 25, by way of explanation, it can provide a certificate such as an X.509 certificate, which is a text file that is used to contain information about an individual, together with an encoding of the individual's public encryption key to the system described herein. The certificate file is then digitally signed by the certificate authority 21 that issued it. If it is desired to use the public keys of a number of individuals in an open context, there has to be a way of accessing the X.509 certificates. This can be done by placing them on a lightweight directory access protocol server (LDAP) such as the LDAP certificate directory server 25 shown, through which access to those certificates can be provided. For example, LDAP servers are provided commercially through a number of entities, and it is possible to obtain from such servers another party's public key certificate, for example, if it is desired to provide digitally signed, encrypted electronic mail.

More specifically, LDAP is a protocol on a data architecture for storing name-value pairs and on an LDAP certificate directory server 25 there would be stored certificates, such as X.509 certificates bound to each individuals' name.

With respect to the application database server 23, it is also conventional and well known to those of ordinary skill in the art. Such an application database server 23 can be implemented using Java Servlets or Enterprise Java Beans (EJBs), which are typically small packets of functionality to make it easy and more efficient to use the more sophisticated Java implementation of web server 19 functionality. In operation, the web server 19 receives a request for a certain web page and in that web page is a reference to some call onto a piece of Java functionality that is written as a Java Servlet. An architecture known generally as the application database server 23 architecture allows the web server 19 to call functionality in the database server using Java Servlets or EJBs 23. The application/database server 23 is typically a separate machine that is specifically optimized to support the invocation of that kind of functionality, encoded, for example, as Java Servlets. More particularly, the application database server 23 allows invoking of precompiled and packaged functionality that is written in the form of Java Servlets, EJBs, or some other type of reusable component.

In the case of the present system and method, the reusable functionality will involve, for example, delivery of a ballot, which can be either in the form of an HTML or XML document, or for enhanced security as will be described hereafter, in the form of a bit-map.

Thus, when a user interacts with the web server 19 from their PC 11, a Servlet, or one or more EJBs, processes the request for the user to register with the system, including a request to cast a ballot. The Servlet or EJBs that are invoked present the ballot to the user, and handle the interaction with the user in the course of casting the vote.

If it is desired to look at the results of an election, another Servlet or a different set of EJBs can be invoked to support that functionality. As may be appreciated by those of ordinary skill in the art, fine-grained packaging of functionality can be defined depending on the capabilities to be implemented as described hereafter.

In one implementation, a Transfer Agent 27 may also be tied into the system and would be responsible for the registration of individuals who are legitimately, legally allowed to vote in a meeting of a Particular Company. One way of conducting the registration is the conventional interacting in person with the Transfer Agent, or through conventional mail. It is contemplated herein that such registration could be accomplished over the network, such as the global computer network 17, in a manner that it may be desired to have an electronic interface to the Transfer Agent 27.

As will also be appreciated, in the case of implementing an interface with the Transfer Agent 27, some kind of X.509 certificate exchange as discussed previously could also be implemented, and the use of certificates would serve to authenticate any sort of interaction with the Transfer Agent 27. In addition, if an individual submitted a registration or request, it could be digitally signed and thus would require the individual's public key certificate in order to validate the signature.

In all cases, it would be required to digitally sign some electronic document, and the digital signature would have associated with it a well-known identity which can be looked up on a server such as an LDAP certificate directory server 25 to obtain the public key certificate corresponding to the claimed identity, and to then verify that the digital signature is actually a signature that could only have been generated by the individual having the claimed identity.

This is all standard public key infrastructure technology and well known to those of ordinary skill in the art. In the case of the Transfer Agent 27, this could be done through a certified agent for registering the voters, and there might be several methods by which such agents could be implemented and authorized by the Transfer Agent 27. Irrespective of what system is implemented, the agent would be acting as a front end to the Transfer Agent 27, and proxying the registration to them, and so, it would have to be legally authorized to do so.

While on the server side a number of different individual functional components are shown, it will be appreciated as an alternative that all the functions can be implemented on a single server, or depending on the size of the system, the functions can be allocated to separate servers which themselves may be replicated. This is an alternative architectural approach well known to those of ordinary skill in the art, and only for the sake of clarity has the system been shown in FIG. 3 as separate boxes, which could be co-located on a single machine or duplicated or replicated on multiple boxes depending on the load and degree of redundancy and tolerance desired.

FIG. 4 illustrates in block diagram form the data and information flow which will occur in a system and method as described herein. The components of data flow are shown divided by a dashed line 45 which separates the client 41 side which relates to the individual and the individual's PC, and is separated from the server 43 side.

A ballot 51 is shown on the client 41 side which has been delivered from the server 43 side and can be some form of electronic document. The document can take various forms but for purposes of the description herein, the ballot 51 is assumed to be an HTML form document, although more secure type and untamperable documents such as bit-map representations can also be deployed in accordance with the system and method.

The difficulty in building a system and method for such voting is being able to verify that only a single individual can cast a ballot, that they can cast only one ballot, and that it cannot be tampered with or undetectably altered or detected in any manner. FIG. 4 illustrates the essential implementation for being able to achieve these goals.

The ballot 51 is delivered, for example, to the home PC 11 through the web server 19 from the application database server 23, all of which were previously described with respect to FIG. 3. Using the home PC 11, through a web browser, an individual can go through and make selections on the ballot, and after pressing enter or casting the ballot, the individual's PC 11 transmits back a subset of that form consisting of the ballot choices and the voter's digital signature of the ballot choices, DS(B,c).

Thus as is shown in FIG. 4, in the top arrow line from the ballot 51, the selection is delivered as a representation to the server side 55. The ballot and response values are structured in a way that it is easy to read the response values and determine which issues or offices were being voted on, and what the selections were. Those values are parsed and stored into a relational database, the structure of which will be described hereafter with reference to a separate figure. When the ballot is received on the server side 43 as shown by the dashed line box 53, the server computes DS(B,s), a digital signature of the ballot using the server 43 private key.

In FIG. 4, in labels such as DS( . . . ,C) or DS( . . . ,c), an upper case letter means a public key, and a lower case letter means a secret or private key, so that in any particular block, this refers to the fact that when a ballot is received, the server creates a digital signature of the ballot using the server's secret or private key. On the client 41 side, when an individual casts a ballot 51, the client 41 side creates a digital signature of the ballot 57 using the individual's secret or private key. Thus, both of these signatures, one created by the individual, and the other created by the server, can only have been created by the respective entities because they are both signatures that are created using the respective secret or private keys.

The individual's signature of the ballot is then delivered to the server 43 side where it is combined with three other elements at block 59. Specifically, the server's signature 53 is combined with the individual's signature 57 along with a vote serial number (VSN) which is, for example, like a ballot serial number and can be an arbitrary number that goes from one to infinity. The vote serial number can be generated per election, and has no relationship to the voter, and is just an incidental sequence number that indicates a vote delivered in the election. Those three elements are then digitally signed by the server yielding DS(C,s), and the four combine into an aggregation of core components which is a ballot confirmation token. This allows confirmation that a particular ballot has been retained in the system and no tampering has occurred. That token is then transmitted back to the individual as a confirmation token 61. The confirmation token 61 can then be encrypted with the individual's public key, thus rendering it undecipherable to anyone except the individual.

Such encryption is not mandatory but may be desirable, depending on other specific implementations of the system and method. For purposes of the disclosure herein, it is noted that while the term “token” is referred to, it could be characterized as a data element which is the signature confirmation by the server, in particular, the confirmation which has three components and a digital signature. Thus, by tying these components together, and having the server sign the components, if later on someone submits the confirmation, the server can verify that the confirmation was issued by the server, minimizing the possibility that confirmations can be forged.

On the server 43 side, the server's digital signature is also recorded along with the vote or ballot as shown at block 55. If it becomes desirable to verify that all of the ballots cast in the election have been untampered with, that can be done on the server 43 side using only the contents of the database and the server ballot signatures which have been recorded in the data store.

This is further illustrated by arrow 63 which illustrates universal verifiability. More specifically, a search is conducted through the database in a manner indexed to a vote serial number, and for each vote serial number, a ballot is reconstructed. The reconstructed ballot has no identification back to the voter and is completely anonymous. However, the ballot responses are the same as those that the individuals generated when the ballot was cast. A digital signature can then be created over the reconstructed ballot using the server's public key, and that signature can be verified against the signature that was recorded when the individual cast the ballot that was created using the server's private key. Thus, the arrow 63 represents the validation of the server's ballot signature created with its private key, against the server's ballot signature that was generated from the reconstructed ballot using the server's public key. This can be done for all of the ballots stored in the system, and thus, it can be verified that none of the ballots have been tampered with at any point in time after a ballot has been cast. This is referred to as universal verifiability, which refers to the property that allows for verification that for all voters none of the ballots have been forged, deleted or altered.

Consider now the case where an individual would want to connect to the system, i.e., on the server 43 side to determine if their ballot vote is properly recorded. In such a case, the individual can present vote confirmation 61 through a transmission 67 to the server 43 side. Of course, the individual will have to decrypt the confirmation 61 as previously discussed using their private key. The confirmation is then presented to the system which decomposes the confirmation into four components, which are represented by blocks 69, and have been previously discussed with reference to blocks 59 and 61.

The digital signature on that confirmation can then be recomputed, and it can be verified that the confirmation has not been altered. Having done so, the vote serial number can then be extracted from the confirmation, and the database can be indexed to allow reconstruction of the voter's ballot exactly as cast.

The two horizontal arrows 71 and 73 illustrate what is known as individual verifiability. The server's ballot signature can be extracted out of the confirmation and validated against the server's ballot signature that is generated from the reconstructed ballot. This is demonstrated by the exchange which occurs through arrow 71. The individual's ballot signature that was computed using the individual's private key can also be validated by the comparison represented by arrow 73 against the digital signature that has taken over the reconstructed ballot using the voter's public key. This can be done because the communication between the individual and the server is protected, as illustrated later in FIG. 5, by a secure socket layer (SSL) connection 101 that provides temporary access to the individual's public key.

In fact, in such an implementation, the public key of the individual on the individual's end of the connection can be obtained outside of the system and once it is known what the individual's public key is, the requirement for an LDAP certificate directory server 25 to obtain the public key can be eliminated.

As may be appreciated from the discussion of individual verifiability, in contrast to universal verifiability; individual verifiability provides two ways of verifying by using either the server's digital signature or the individual's digital signature on the ballot.

FIG. 5 shows in greater detail the general architecture shown in FIG. 3, and the data flow shown in FIG. 4. Specifically, the upper part of FIG. 5 shows the various components of the system along with boxes showing the data flow, with the lower portion of FIG. 5 showing in greater detail the various resultant tables assembled with ballots that have been cast.

A smart card reader 13 can be implemented connected to an individual's PC 11 on a smart card 103 which is read by the smart card reader 13, and can have stored thereon an individual's private (or secret) encryption key. A certificate such as an X.509 certificate for their public key, and their voter identification number which is an arbitrary sequence number generated when they register with the system, can also be stored on the smart card 103. The individual's PC 11 will typically be running a standard web browser 105, such as is commercially available from Netscape Corporation, and inside the web browser 105 is a Java script interpreter 107 with the ballot 51 presented within the web browser 105. Although the ballot has been previously described, and is illustrated in FIG. 3, as an HTML or XML document, it can also take other forms such as a bit-map, if enhanced security is desired.

While a personal computer 11 has been shown with a standard commercially-available browser 105, it may also be appreciated that such browsers are often not sufficiently secure. Thus, as contemplated herein, it is also possible to implement in a manner well known to those of ordinary skill in the art, a non-commercial browser which avoids the security pitfalls of currently-existing commercial browsers.

More specifically, it is common for malicious software to read/modify sensitive files on unsecure personal computers. Such unsecure personal computer platforms can include those which are Intel processor/Microsoft Windows operating system, or Apple MacIntosh operating system-based. Specifically, in such commercial systems, the security ends at the client. As a result, the entire system may be vulnerable to attack by malicious software executing within the individual's PC. With no individual platform security mechanisms, such attacks could detrimentally impact information confidentiality, integrity, authenticity, or availability within the overall system.

In order to address such a problem which may be inherent in a conventional commercial web browser, and with ballots such as an HTML or XML document ballot 51, a protocol can be implemented that combines anonymous context, and visual obfuscation to make it virtually impossible for malicious software to knowledgably and undetectably interfere with a concurrently executing individual PC application in order to impact information confidentiality, integrity and authenticity.

In accordance with the specific implementation of such security as contemplated herein, and as will be readily apparent to those of ordinary skill in the art, cryptographic techniques, protocols and data representation can be implemented in order to increase the work required of malicious software beyond what can be accomplished within a voting session at an individual's personal computer 11. Specifically, implementation of visual obfuscation is intended to defeat the ability of malicious software to determine or alter network content. Such a technique would include but not be limited to variation of text, font, size, spacing, etc. The wording of the text associated with ballot choices, the location of graphic components, the shape of image of choice/selection targets, explicit or implicit relationships between graphical elements, and in some cases, color, can also be implemented in an obfuscating manner. In addition, a technique for converting content in HTML or XML format to image format can be employed as will be readily apparent to those of ordinary skill in the art, making it difficult, with current OCR algorithms to intercept and alter the limited ballot information being transmitted. Such OCR techniques are generally processor intensive, and thus attempts by malicious software to alter or interpret such ballot information would be readily detected.

Thus, as shown in the FIG. 5 a voter D and the public key of the individual is transferred at 118 over an SSL connection 101 to the web server 19 on the server 43. The server side 43 which includes a number of function boxes assembled as one box 109. The web server 19 which includes an execution environment for Java Servlets 111 then sends a ballot 119 obtained from a collection of ballots 113, to the individual PC 111 through a transmission 119. The individual then marks the ballot and returns the ballot as shown with arrow 121 with the choices thereon. The confirmation shown as block 61 is then returned as shown by arrow 123.

It will be appreciated that within the collection 109 of function boxes, separate functionality and information is provided, for example, from the collection of election ballots 113, vote serial numbers 119, and certificates 117, characterized preferably as X.509 certificates. In the Figure, block 115 is typically the application database server 23 shown in FIG. 1 and serves to compile the election voter table, election database and optionally, a voter demographics database, all of which will be described hereafter with reference to the lower half of FIG. 5.

More specifically, the lower half of FIG. 5 illustrates how the various pieces of information/data are assembled. At block 151 it is seen that tb provide voter anonymity, while retaining non-repudiation and election integrity, ballots are re-signed by the server before appending to the election database. In this case, at box 151, there are reflected the choices the individual ballot items that the individual voter casts a vote for, and are stored in an election results table 157.

Table 157 conceptually includes four columns. The first column is the election in which the votes are cast. A separate database can be created per election but could also be done in this manner. The table 157 is indexed by the vote serial number (VSN), the issue or office being voted on, and the choice the individual makes. Thus, this is the table in which the ballot choices are stored. The voter's serial number is also stored in a table 155 which is an election verification table. The purpose of this table is to retain the digital signatures that protect the integrity of the ballot and the election verification table has at least three columns and perhaps others. The election verification table is indexed by the vote serial number. It includes a column for time and a column for the digital signature. Optionally, demographic data could also be input into the election verification table 155 as long as this information would not, through inference or aggregation, divulge the voter's identity.

On the left side is shown the election voter table 153 which is a hashed table that in order to achieve the appropriate voting verification, to ensure that individuals can vote in accordance with their voting rights, provides that the voter identification or ID is encrypted or hashed using a one-way transform. One option is to employ an encryption using the individual voter's public key, but any one-way transform would work. The contents of the table 153, since they are generated by a one-way hashed function are not reversible, so it is impossible to look into the table to see who voted. However, if an individual tries to vote more than their appropriate voting rights, the hash entry will collide with any additional attempt to vote, and thus, there is provided a way of detecting a subsequent voting attempt without divulging anything about the identity of the individual.

Turning now to FIG. 6, there is illustrated in block diagram form a large-scale production voting system architecture. Registration clients 201 at their personal computers are shown as able to register through connection through the global computer network 205, through a voting firewall 207, web servers 209 and application database servers 211, which may be ultimately connected to a Transfer Agent system 221. The Transfer Agent system 221 may provide registration information to a registration server 215 which cooperates as previously described with certificate directory servers 219, and certificate authority servers 217, and in cooperation with the other elements to allow delivery of a ballot to voting clients 203 to accomplish voting as previously described herein.

In the context of the present invention, the term “electronic transmission” means any form of communication, not directly involving the physical transmission of paper, that creates a record that may be retained, retrieved and reviewed by a recipient thereof, and that may be directly reproduced in paper form by such a recipient through an automated process.

In yet another embodiment of the present invention, the organization wishing to hold the virtual meeting provides each of the eligible participants with a device that permits its holder to be recognized as an eligible participant. For instance, the organization might provide each eligible participant with a card that can be read by a CD-ROM drive and contain a “key” that enables its holder to have access to the meeting. Alternatively, the organization might provide each eligible participant with a U.S.B. device that encodes a “key” that enables its holder to have access to the meeting.

We claim:

1. A method of conducting a meeting comprising the steps of
A. Notifying potential meeting attendees of said meeting, said notification including a notice that complies with any applicable requirements, an agenda, and a digital certificate that is sufficient to authorize their attendance at an electronic meeting space reserved for said meeting;
B. Providing said electronic meeting space;
C. Checking the digital certificate of any person seeking admission to said electronic meeting space and only admitting persons having an appropriate digital certificate;
D. Monitoring the attendance in said electronic meeting space and any associated in-person meeting space and when a quorum of attendees is reached, calling said meeting to order;
E. Providing an orderly electronic discussion among the persons in attendance at the meeting; and
F. Delivering, collecting, and tabulating encrypted electronic ballots to those persons attending the meeting electronically.

2. A system for conducting a virtual meeting comprising
[a]a computer having:
associated memory and processing means for executing at least one program from said associated memory,
at least one communication link that can send electronic signals to, and receive electronic signals from at least one remote user
said at least one program including a meeting hosting program that receives instructions from users logged onto said computer and transmits such instructions to other users concurrently logged onto said computer,
said at least one program including a authentication evaluating program, and
said processing means executing said authentication evaluating program to enable said computer to evaluate the whether a remote user seeking access to said computer is authorized to have such access.

3. A system according to claim 2 further comprising:
a means for providing any authenticated users logged on to said computer with proceedings from at least one physical meeting space concurrent with said virtual meeting.

4. A system according to claim 3 in which said means for providing users with proceedings includes at least one of the group consisting of a camera means and a microphone means.
